(19) United States
(12) Patent Application Publication
(10) Pub. No.: US 2025/0311784 A1
(43) Pub. Date: Oct. 9, 2025

(54) PREDICTIVE AGING COMPENSATION AGAINST COIL DEGRADATION IN INDUCTIVE HEATING E-CIGARETTE APPLICATIONS

(71) Applicant: STMicroelectronics International N.V., Geneva (CH)

(72) Inventors: Yanlei Li, Beijing (CN); Wei Hua Li, Beijing (CN); Wulin Zhou, Shenzhen (CN); Wanli Yang, Beijing (CN); Xuning Wang, Beijing (CN); Yingying Sun, Beijing (CN)

(21) Appl. No.: 18/630,671

(22) Filed: Apr. 9, 2024

(51) Int. Cl. A24F 40/465; A24F 40/50; H05B 6/36

(52) U.S. Cl. CPC A24F 40/465; A24F 40/50; H05B 6/36

(57) ABSTRACT

An e-cigarette heating system is disclosed, the system including a heating element; an inductive coil configured to transfer energy to the heating element in response to a heating signal; a tank capacitor; a driver configured to generate the heating signal; a controller configured to cause the driver to generate the heating signal; an analog to digital converter configured to digitize an analog signal; and a digital circuit configured to transmit a resonance frequency signal to the controller, where the digital circuit is configured to transmit a Q signal to the controller, where the Q signal provides an indication of a quality factor (Q) of the tank capacitor and the inductive coil to the controller, where the controller is configured to determine an operating frequency of the heating signal, and where the controller is configured to determine an aging condition of the inductive coil based on the Q signal.

### TECHNICAL FIELD

The present disclosure generally relates to a circuit for heating an e-cigarette, as well as to determining circuit parameters for the heating circuit.

### BACKGROUND

Some e-cigarette heating systems use inductive energy transfer circuits to increase a temperature of a heating metal to a desired temperature range. The heating systems may manage energy transfer by changing a frequency of a signal applied to a tank circuit having a capacitance and an inductance.

### SUMMARY

One embodiment is an e-cigarette heating system, the system including a heating element; an inductive coil configured to transfer energy to the heating element in response to a heating signal; a tank capacitor; a driver configured to generate the heating signal; a controller configured to cause the driver to generate the heating signal; an analog to digital converter configured to digitize an analog signal; and a digital circuit configured to transmit a resonance frequency signal to the controller, where the digital circuit is configured to transmit a Q signal to the controller, where the Q signal provides an indication of a quality factor (Q) of the tank capacitor and the inductive coil to the controller, where the controller is configured to determine an operating frequency of the heating signal, and where the controller is configured to determine an aging condition of the inductive coil based on the Q signal.

Another embodiment is a method of using an e-cigarette heating system, the method including determining a quality (Q) factor of a heating circuit; determining an aging condition of the heating circuit based on the Q factor; determining a resonance frequency of the heating circuit; determining an operating frequency of the heating circuit based on the resonance frequency of the heating circuit; and generating a heating signal having the operating frequency to heat a heating element with the heating circuit.

Another embodiment is an e-cigarette heating system, including a heating element; an inductive coil configured to transfer energy to the heating element in response to a heating signal; a fixed tank capacitor; a selectable tank capacitor; a driver configured to generate the heating signal; a controller configured to cause the driver to generate the heating signal; and a measurement circuit, where the measurement circuit is configured to transmit a resonance frequency signal providing an indication of a resonance frequency of the fixed tank capacitor and the inductive coil to the controller, where the controller is configured to cause the selectable tank capacitor to be connected across the fixed tank capacitor in response to the resonance frequency signal indicating that the resonance frequency of the fixed tank capacitor and the inductive coil is greater than a frequency threshold.

### BRIEF DESCRIPTION OF THE DRAWINGS

For a more complete understanding of one or more embodiments of the present disclosure, and the advantages thereof, reference is now made to the following descriptions taken in conjunction with the accompanying drawings, in which:

FIG. 1 shows a schematic circuit block diagram of an e-cigarette heating system according to some embodiments.

FIG. 2 shows a waveform diagram used to characterize electrical parameters of an e-cigarette heating system according to some embodiments.

FIG. 3 shows a flowchart diagram illustrating a method of using an e-cigarette heating system according to some embodiments.

FIG. 4 shows a flowchart diagram illustrating a method of using an e-cigarette heating system according to some embodiments.

FIG. 5 shows a flowchart diagram illustrating a method of using an e-cigarette heating system according to some embodiments.

FIG. 6 shows a schematic circuit block diagram of an e-cigarette heating system according to some embodiments.

FIG. 7 shows a flowchart diagram illustrating a method of using an e-cigarette heating system according to some embodiments.

FIG. 8 shows a flowchart diagram illustrating a method of using an e-cigarette heating system according to some embodiments.

FIG. 9 shows a flowchart diagram illustrating a method of using an e-cigarette heating system according to some embodiments.

FIG. 10 shows a flowchart diagram illustrating a method of using an e-cigarette heating system according to some embodiments.

Corresponding numerals and symbols in the different figures generally refer to corresponding parts unless otherwise indicated. The figures are drawn to illustrate the relevant aspects of the embodiments and are not necessarily drawn to scale. The edges of features drawn in the figures do not necessarily indicate the termination of the extent of the feature.

### DETAILED DESCRIPTION OF ILLUSTRATIVE EMBODIMENTS

Illustrative embodiments of the system and method of the present disclosure are described below. In the interest of clarity, all features of an actual implementation may not be described in this specification. It will of course be appreciated that in the development of any such actual embodiment, numerous implementation-specific decisions may be made to achieve the developer's specific goals, such as compliance with system-related and business-related constraints, which will vary from one implementation to another. Moreover, it should be appreciated that such a development effort might be complex and time-consuming but would nevertheless be a routine undertaking for those of ordinary skill in the art having the benefit of this disclosure.

Reference may be made herein to the spatial relationships between various components and to the spatial orientation of various aspects of components as the devices are depicted in the attached drawings. However, as will be recognized by those skilled in the art after a complete reading of the present disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

The making and using of various embodiments are discussed in detail below. It should be appreciated, however, that the various embodiments described herein are applicable in a wide variety of specific contexts. The specific embodiments discussed are merely illustrative of specific ways to make and use various embodiments, and should not be construed in a limited scope.

Induction heating is effective method of heating for use in in E-Cigarette applications. Induction heating systems may use an alternating current heating signal to transfer energy, for example, from an inductive coil to a heating element. The amount of energy transferred to the heating element is dependent on various electrical circuit parameters of the heating circuit and on various signal parameters of the heating signal. For example, in some embodiments, the amount of energy transferred to the heating element is maximized when a frequency of the heating signal matches a resonance frequency of a heating circuit having the inductive coil and a capacitance.

In some embodiments, certain electrical circuit parameters of the heating circuit may be detected or measured, and subsequently used to determine parameters of the heating signal so that proper or desired heating may be achieved by changing or controlling the parameters of the heating signal. For example, a wireless charging transmitter may measure the quality (Q) factor of the transmitter coil and the resonance frequency of the LC heating circuit.

The Q-factor of the transmitter coil is related to its inductance and resistance. In addition, the resonance frequency of the LC heating circuit is related to the inductance and capacitance of the LC heating circuit.

The system efficiency and heating process of e-cigarette is related to the operating frequency. Accordingly, in some embodiments the operating frequency of the heating signal is chosen based on a resonance frequency of the heating circuit.

In some embodiments, a wireless transmitter has a driver that selectively adds capacitance to the heating circuit.

In some embodiments, the aging of a coil can cause a decrease in its inductance and an increase in its resistance, leading to reduced efficiency and potential failure. Regular maintenance and inspection can help detect any signs of aging and prevent failure.

The Q-factor and resonance frequency measurement used in wireless charging may help to determine the presence of a foreign object. A Q-factor measurement may be performed with the wireless transmitter. And, in e-cigarette applications, Q-factor, and resonance frequency measurements can be used to choose an operating frequency for the heating circuit.

The aging of the coil may cause the coil inductance to decrease, and the resonance frequency of the heating circuit to increase in e-cigarette heating applications. The increase of resonance frequency may, for example, lead to the operating frequency of the heating signal being lower than the resonance frequency of the heating circuit, and the e-cigarette may not be heated properly. In addition, the system power efficiency may be lower than normal operation.

The e-cigarette may not be heated in time or even may not be heated to the specified temperature at all because of the coil aging. For example, some e-cigarettes require the heating element, such as a metal workpiece, to be heated to 250° C. in 5 seconds. But because of the aging of the coil, the e-cigarette may need 10 seconds or longer to heat the metal to 250° C., and sometimes the metal workpiece may not reach 250° C. at all.

In addition, the battery life may be reduced due to low power efficiency. For example, the e-cigarette could run 20 times after the battery is fully charged for a new e-cigarette, but if the coil has aged, the e-cigarette may only run 10 times after the battery is fully charged.

In some embodiments, to properly heat the metal workpiece, the operating frequency of the heating signal is usually a bit higher than the resonance frequency of the LC heating circuit. For example, the frequency of the heating signal may be about 1.03 times the resonance frequency of the LC heating circuit. For example, a 520 kHz operating frequency may be chosen for a 503 kHz resonance frequency heating circuit so that the metal workpiece is heated to 250° C. from room temperature in 5 seconds.

One problem of aging is that the aging of a coil can cause a decrease in its inductance and an increase in its resistance. The aging of the tank capacitor may also impact the resonance frequency of the heating circuit. The resonance frequency of the LC heating circuit increases according to LC resonance frequency formula:

$$f = \frac{1}{2 π \times \sqrt{L \times C}}$$

For example, with a 100 nf capacitor, if the coil inductance decreases 10% because of aging, from 1 uH to 0.9 uH, then the resonance frequency would change from 503 kHz to

$$f = \frac{1}{2 π \times \sqrt{L \times C}} = \frac{1}{2 π \times \sqrt{0.9 \times 1 {0}^{- 6} \times 100 \times 1 {0}^{- 9}}} = 531 kHz$$

If the heating signal has a 520 kHz operating frequency to heat the metal workpiece, the system efficiency will be much lower, as the operating frequency is lower than resonance frequency. If the inductance decreases more, the metal workpiece may not be heated to 250° C. in 5 seconds or may not be heated to 250° C. at all.

The induction power of the coil is maximized when the heating signal operating frequency is equal to the LC heating circuit resonance frequency. Accordingly, the induction power decreases with the increasing of operating frequency when the operating frequency is higher than the resonance frequency, and the induction power increases with the decreasing operating frequency when the operating frequency is higher than the resonance frequency. Similarly, the induction power decreases with the decreasing operating frequency when the operating frequency is less than the resonance frequency, and the induction power increases with the increasing operating frequency when the operating frequency is less than the resonance frequency.

Therefore, if the operating frequency is lower than the resonance frequency, control system logic for maintaining proper temperature may fail. For example, the control system properly operating with the operating frequency being greater than the resonance frequency will increase the operating frequency to decrease output power, and will decrease the operating frequency to increase the output power. However, if the operating frequency is less than the resonance frequency, the control system decreasing the operating frequency will decrease the output power, resulting in excessive cooling of the heating element, and the control system increasing the operating frequency will increase output power, resulting in excessive heating of the heating element.

Rather than having to replace the e-cigarette or various portions thereof, embodiments having the advantageous features discussed herein allow for extended coil life and battery life. In addition, some embodiments have more power efficient and shorter heating times.

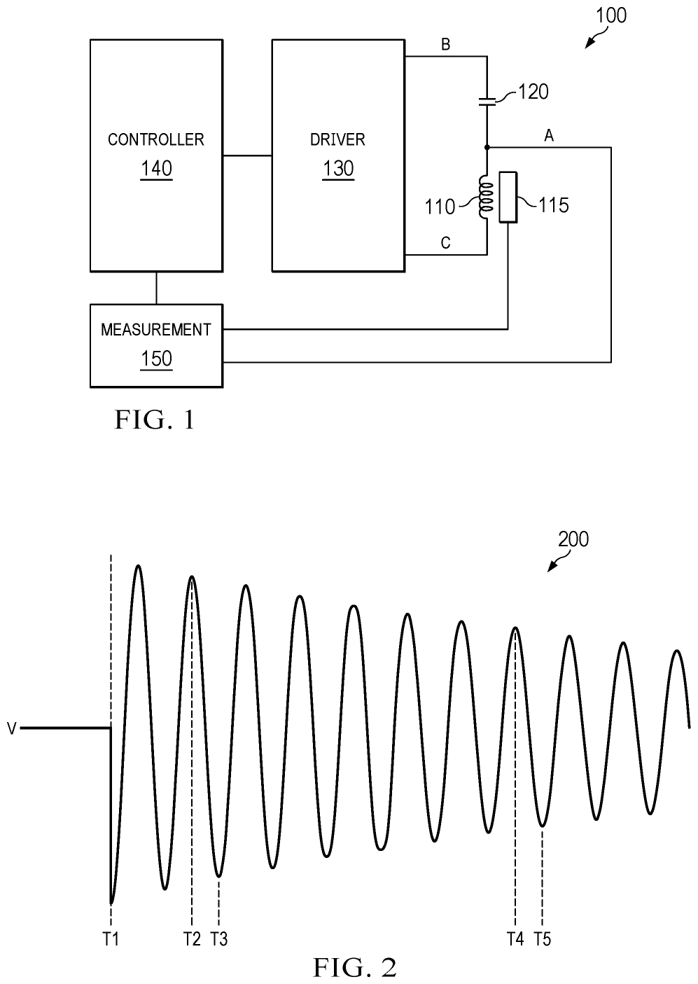

FIG. 1 shows a schematic circuit block diagram of an e-cigarette heating system 100 according to some embodiments. E-cigarette heating system 100 includes inductive coil 110, heating element 115, tank capacitor 120, driver 130, controller 140, and measurement circuit 150. E-cigarette heating system 100 is an example of a system having the beneficial aspects discussed herein. Other e-cigarette heating systems have one or more of the beneficial aspects discussed herein.

The e-cigarette heating system 100 may form an induction heating system which uses an alternating current heating signal in inductive coil 110 to transfer energy to heating element 115. In some embodiments, the heating element comprises a metal workpiece. In some embodiments, the heating element 115 comprises a negative temperature coefficient metal.

In the illustrated embodiment, driver 130 is configured to generate a heating signal for the heating circuit including tank capacitor 120 and inductive coil 110. The inductive coil 110 inductively transfers energy to the heating element 115, and the heating element receives the transferred energy. Accordingly, the heating signal from driver 130 may be used to increase, decrease, or maintain a temperature of the e-cigarette, or of the heating element of the e-cigarette.

The amount of energy transferred to the heating element is maximized when a frequency of the heating signal matches a resonance frequency of the heating circuit having the inductive coil 110 and the tank capacitor 120.

Measurement circuit 150 may be configured to generate a temperature signal for controller 140. For example, measurement circuit 150 may include an electronic thermometer configured to sense the temperature of heating element 115. In addition, measurement circuit 150 may be configured to generate the temperature signal for controller 140, where the measurement signal provides an indication to controller 140 of the temperature of the heating element 115.

Controller 140 may be any processing circuit, such as a microcontroller or other processor or controller configured to receive the temperature signal from measurement circuit 150 and to transmit control signals to the driver 130. In addition, the control signals from the controller 140 cause the driver 130 to generate the heating signal for the heating system 100 based in part on the temperature signal.

For example, if controller 140 determines that the temperature signal indicates that the heating element 115 has a temperature less than a target temperature or target temperature range, controller 140 may cause the driver 130 to modify the heating signal so as to increase the temperature of heating element 115. For example, controller 140 may cause the driver 130 to modify the operating frequency of the heating signal so as to increase the temperature of the heating element 115 by causing the operating frequency of the heating signal to be closer to the resonance frequency of the heating circuit. Because the amount of energy transferred to the heating element 115 is maximized when the operating frequency of the heating signal is equal to the resonance frequency of the heating circuit, causing the operating frequency of the heating signal to be closer to the resonance frequency of the heating circuit increases the amount of energy transferred to the heating element 115, and the temperature of the heating element 115 increases.

Similarly, if controller 140 determines that the temperature signal indicates that the heating element 115 has a temperature greater than the target temperature or target temperature range, controller 140 may transmit control signals to the driver 130 that cause the driver 130 to modify the heating signal so as to decrease the temperature of heating element 115. For example, controller 140 may transmit control signals to the driver 130 that cause the driver 130 to modify the operating frequency of the heating signal so as to decrease the temperature of the heating element 115 by causing the operating frequency of the heating signal to be farther from the resonance frequency of the heating circuit. Because the amount of energy transferred to the heating element 115 is maximized when the operating frequency of the heating signal is equal to the resonance frequency of the heating circuit, causing the operating frequency of the heating signal to be farther from the resonance frequency of the heating circuit decreases the amount of energy transferred to the heating element 115, and the temperature of the heating element 115 decreases.

In some embodiments, measurement circuit 150 determines the resonance frequency of the heating circuit, for example, as discussed in more detail elsewhere herein. In addition, measurement circuit 150 may be configured to generate a resonance frequency signal for controller 140, where the resonance frequency signal indicates a resonance frequency of the heating circuit.

Accordingly, in response to controller 140 determining that the temperature of the heating element is to be increased or decreased, controller 140 may determine whether to increase or decrease the operating frequency of the heating signal according to whether the current operating frequency is greater than or less than the resonance frequency of the heating circuit as indicated by the resonance frequency signal.

For example, in response to the resonance frequency signal indicating that the current operating frequency of the heating signal is greater than the resonance frequency of the heating circuit, to increase the temperature of the heating element 115, controller 140 may be configured to reduce the operating frequency of the heating signal. Similarly, in response to the resonance frequency signal indicating that the current operating frequency of the heating signal is greater than the resonance frequency of the heating circuit, to decrease the temperature of the heating element 115, controller 140 may be configured to increase the operating frequency of the heating signal.

Additionally, in response to the resonance frequency signal indicating that the current operating frequency of the heating signal is less than the resonance frequency of the heating circuit, to increase the temperature of the heating element 115, controller 140 may be configured to increase the operating frequency of the heating signal. Similarly, in response to the resonance frequency signal indicating that the current operating frequency of the heating signal is less than the resonance frequency of the heating circuit, to decrease the temperature of the heating element 115, controller 140 may be configured to decrease the operating frequency of the heating signal.

In some embodiments, controller 140 is configured to persistently generate heating signals which are greater than an expected resonance frequency of the heating circuit.

Accordingly, in response to controller 140 determining that the temperature of the heating element is to be increased or decreased, controller 140 may not determine whether to increase or decrease the operating frequency of the heating signal according to whether the current operating frequency is greater than or less than the resonance frequency of the heating circuit as indicated by the resonance frequency signal.

For example, in response to controller 140 determining that the temperature signal indicates that the heating element 115 has a temperature less than the target temperature or target temperature range, controller 140 may modify the heating signal so as to increase the temperature of heating element 115 without reference to a resonance frequency signal indicating a resonance frequency of the heating circuit. For example, controller 140 may modify the operating frequency of the heating signal so as to increase the temperature of the heating element 115 by decreasing the operating frequency of the heating signal.

Similarly, in response to controller 140 determining that the temperature signal indicates that the heating element 115 has a temperature greater than the target temperature or target temperature range, controller 140 may modify the heating signal so as to decrease the temperature of heating element 115 without reference to a resonance frequency signal indicating a resonance frequency of the heating circuit. For example, controller 140 may modify the operating frequency of the heating signal so as to decrease the temperature of the heating element 115 by increasing the operating frequency of the heating signal.

In embodiments where controller 140 is configured to persistently generate heating signals which are greater than an expected resonance frequency of the heating circuit, controller 140 may be configured to change the operating frequency of the heating signal based on the resonance frequency of the heating circuit as indicated by the resonance frequency signal. For example, in some embodiments, controller 140 is configured to determine an operating frequency of the heating signal which is a predetermined fixed frequency less than the resonance frequency of the heating circuit. For example, in some embodiments, controller 140 is configured to set the operating frequency of the heating signal to be 20 kHz less than the resonance frequency of the heating circuit. In some embodiments, controller 140 is configured to determine an operating frequency of the heating signal which is a predetermined fixed factor less than the resonance frequency of the heating circuit. For example, in some embodiments, controller 140 is configured to set the operating frequency of the heating signal to be 0.97 times the resonance frequency of the heating circuit.

In embodiments where controller 140 is configured to persistently generate heating signals which are greater than an expected resonance frequency of the heating circuit, once controller 140 has changed the operating frequency of the heating signal based on the resonance frequency of the heating circuit as indicated by the resonance frequency signal, controller 140 may be configured to modify the frequency of the heating signal according to the temperature signal, for example, as discussed above.

In some embodiments, controller 140 is configured to persistently generate heating signals which are less than an expected resonance frequency of the heating circuit.

Accordingly, in response to controller 140 determining that the temperature of the heating element is to be increased or decreased, controller 140 may not determine whether to increase or decrease the operating frequency of the heating signal according to whether the current operating frequency is greater than or less than the resonance frequency of the heating circuit as indicated by the resonance frequency signal.

For example, in response to controller 140 determining that the temperature signal indicates that the heating element 115 has a temperature less than the target temperature or target temperature range, controller 140 may modify the heating signal so as to increase the temperature of heating element 115 without reference to a resonance frequency signal indicating a resonance frequency of the heating circuit. For example, controller 140 may modify the operating frequency of the heating signal so as to increase the temperature of the heating element 115 by increasing the operating frequency of the heating signal.

Similarly, in response to controller 140 determining that the temperature signal indicates that the heating element 115 has a temperature greater than the target temperature or target temperature range, controller 140 may modify the heating signal so as to decrease the temperature of heating element 115 without reference to a resonance frequency signal indicating a resonance frequency of the heating circuit. For example, controller 140 may modify the operating frequency of the heating signal so as to decrease the temperature of the heating element 115 by decreasing the operating frequency of the heating signal.

In embodiments where controller 140 is configured to persistently generate heating signals which are less than an expected resonance frequency of the heating circuit, controller 140 may be configured to change the operating frequency of the heating signal based on the resonance frequency of the heating circuit as indicated by the resonance frequency signal. For example, in some embodiments, controller 140 is configured to determine an operating frequency of the heating signal which is a predetermined fixed frequency greater than the resonance frequency of the heating circuit. For example, in some embodiments, controller 140 is configured to set the operating frequency of the heating signal to be 20 kHz greater than the resonance frequency of the heating circuit. In some embodiments, controller 140 is configured to determine an operating frequency of the heating signal which is a predetermined fixed factor greater than the resonance frequency of the heating circuit. For example, in some embodiments, controller 140 is configured to set the operating frequency of the heating signal to be 1.03 times the resonance frequency of the heating circuit.

In embodiments where controller 140 is configured to persistently generate heating signals which are less than an expected resonance frequency of the heating circuit, once controller 140 has changed the operating frequency of the heating signal based on the resonance frequency of the heating circuit as indicated by the resonance frequency signal, controller 140 may be configured to modify the frequency of the heating signal according to the temperature signal, for example, as discussed above.

FIG. 2 shows a waveform 200 used to characterize electrical parameters of e-cigarette heating system 100 according to some embodiments. For example, waveform 200 may be sensed by measurement circuit 150 at node A of e-cigarette heating system 100. In addition, waveform 200 may be induced by generating an impulse across nodes B and C of e-cigarette heating system 100 at time T1, where the impulse reduces the voltage across nodes B and C to a fixed value, such as 0. Measurement circuit 150 may be configured to calculate various parameters based on waveform 200, and may be configured to provide signals indicating the parameters to controller 140.

In some embodiments, the information of waveform 200 is used by measurement circuit 150, for example to calculate a resonance frequency of heating circuit, for example, by determining the frequency of the ringing response. For example, in some embodiments, measurement circuit 150 includes an analog to digital converter which digitizes waveform 200, and includes digital processing circuitry which determines the frequency of the ringing response. For example, the resonance frequency of the heating circuit may be equal to or estimated as:

$$f = \frac{N}{T 4 - T 2} ,$$

where N is equal to the number of periods between time T2 and time T4, and where T4−T2 is equal to the time duration between time T2 and time T4.

In some embodiments, the information of waveform 200 is used, for example to calculate a quality (Q) factor of the heating circuit, for example, based on the decay rate of the waveform 200. For example, in some embodiments, measurement circuit 150 includes an analog to digital converter which digitizes waveform 200, and includes digital processing circuitry which determines the decay rate of the waveform 200. For example, Q may be equal to or estimated as:

$$Q = \frac{π N}{ln ( ( V 2 - V 3 ) / ( V 4 - V 5 ) )}$$

where N is equal to the number of periods between time T2 and time T4, where V2 is the voltage at time T2, V3 is the voltage at time T3, V4 is the voltage at time T4, and V5 is the voltage at time T5.

In some embodiments, the information of waveform 200 is used, for example to calculate an inductance of the inductive coil of the heating circuit, for example, based on the resonance frequency of the heating circuit, for example as calculated above, and the capacitance of the tank, which is known. For example, in some embodiments, measurement circuit 150 includes an analog to digital converter which digitizes waveform 200, and includes digital processing circuitry which determines the inductance of the inductive coil of the heating circuit. For example, the inductance may be calculated as:

$$L = \frac{1}{4 {π}^{2} \times {f}^{2} \times C}$$

In some embodiments, the information of waveform 200 is used, for example to calculate a resistance of the inductive coil of the heating circuit, for example, based on the resonance frequency of the heating circuit, for example as calculated above, the inductance of the inductive coil, for example, as calculated above, and the Q, for example, as calculated above. For example, in some embodiments, measurement circuit 150 includes an analog to digital converter which digitizes waveform 200, and includes digital processing circuitry which determines the resistance of the inductive coil of the heating circuit. For example, the resistance may be calculated as:

$$R = \frac{2 π \times L \times {f}^{′}}{Q}$$

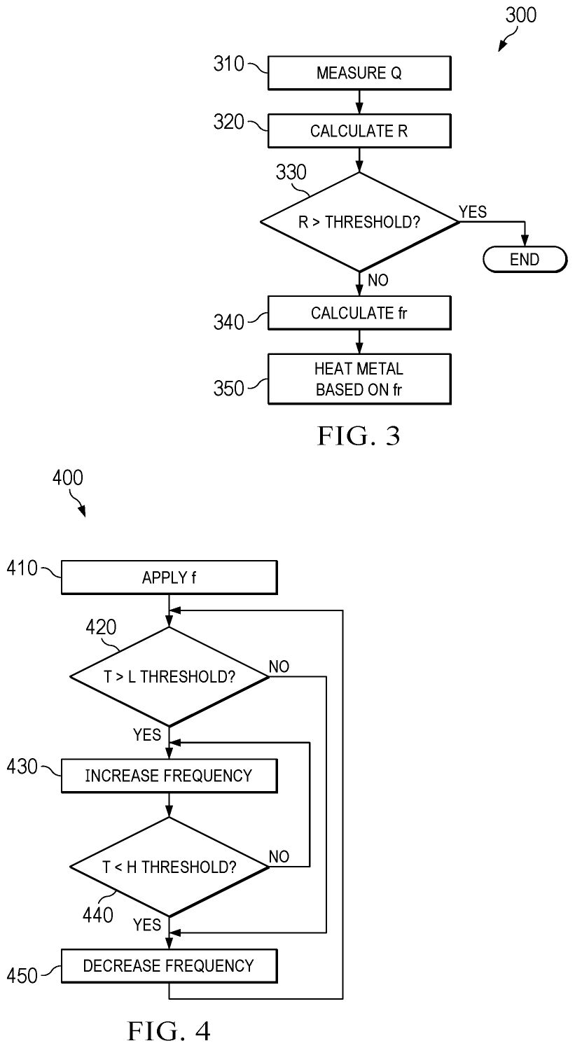

FIG. 3 shows a flowchart diagram illustrating a method 300 of using an e-cigarette heating system according to some embodiments. Method 300 may be performed, for example by a controller, such as controller 140 of e-cigarette heating system 100. In some embodiments, e-cigarette heating system 100 may be configured to perform a method which is different from method 300, and which, for example, has one or more aspects similar or identical to method 300.

At block 310, a quality (Q) factor of a heating circuit is determined. For example, the controller may determine the Q of the heating circuit using a method such as that discussed above with reference to FIG. 2.

At block 320, the resistance of an inductive coil of a heating circuit is determined. For example, the controller may determine the resistance of the inductive coil using a method such as that discussed above with reference to FIG. 2, based for example on the Q determined at block 310.

At block 330, the controller determines whether the resistance determined at block 320 is greater than a threshold. In some embodiments, in response to the resistance determined at block 320 being greater than the threshold, the method stops, and the e-cigarette is not heated. For example, the resistance being greater than the threshold may indicate that the inductive coil has aged more than a tolerable amount.

In response to the resistance determined at block 320 not being greater than the threshold, at block 340, a resonance frequency of the heating circuit is determined. For example, the controller may determine the resonance frequency of the heating circuit using a method such as that discussed above with reference to FIG. 2.

At block 350, a temperature of the heating element of the heating circuit is controlled by generating a heating signal. In some embodiments, a frequency of the heating signal is determined based on the resonance frequency determined at block 340. In some embodiments, the frequency of the heating signal is additionally changed to modify the temperature of the heating element, for example, as discussed above with reference to e-cigarette heating system 100. In some embodiments, the frequency of the heating signal is changed according to either of methods 400 or 500, discussed in more detail below.

FIG. 4 shows a flowchart diagram illustrating a method 400 of using an e-cigarette heating system according to some embodiments. Method 400 may be performed, for example by a controller, such as controller 140 of e-cigarette heating system 100. In some embodiments, e-cigarette heating system 100 may be configured to perform a method which is different from method 400, and which, for example, has one or more aspects similar or identical to method 400. In some embodiments, the controller is configured to perform method 400 as part of performing method 300 discussed above, for example, at block 350.

At block 410, a heating signal having an operating frequency is applied to a heating circuit. In response to the heating signal, a heating element increases in temperature.

At block 420, the controller determines whether the temperature of the heating element is greater than a low threshold. For example, in some embodiments the controller determines whether the temperature of the heating element is greater than 250° C.

In response to the temperature of the heating element not being greater than the low threshold, at block 450, the operating frequency of the heating signal is reduced, and the temperature of the heating element increases. In response to the temperature of the heating element being greater than the low threshold, at block 430, the operating frequency of the heating signal is increased, and the temperature of the heating element decreases.

At block 440, the controller determines whether the temperature of the heating element is less than a high threshold. For example, in some embodiments the controller determines whether the temperature of the heating element is less than 270° C.

In response to the temperature of the heating element not being less than the high threshold, at block 430, the operating frequency of the heating signal is increased, and the temperature of the heating element decreases. In response to the temperature of the heating element being less than the high threshold, at block 450, the operating frequency of the heating signal is decreased, and the temperature of the heating element increases.

In some embodiments, using method 400, the controller causes the temperature of the heating element to substantially remain between the low threshold and the high threshold.

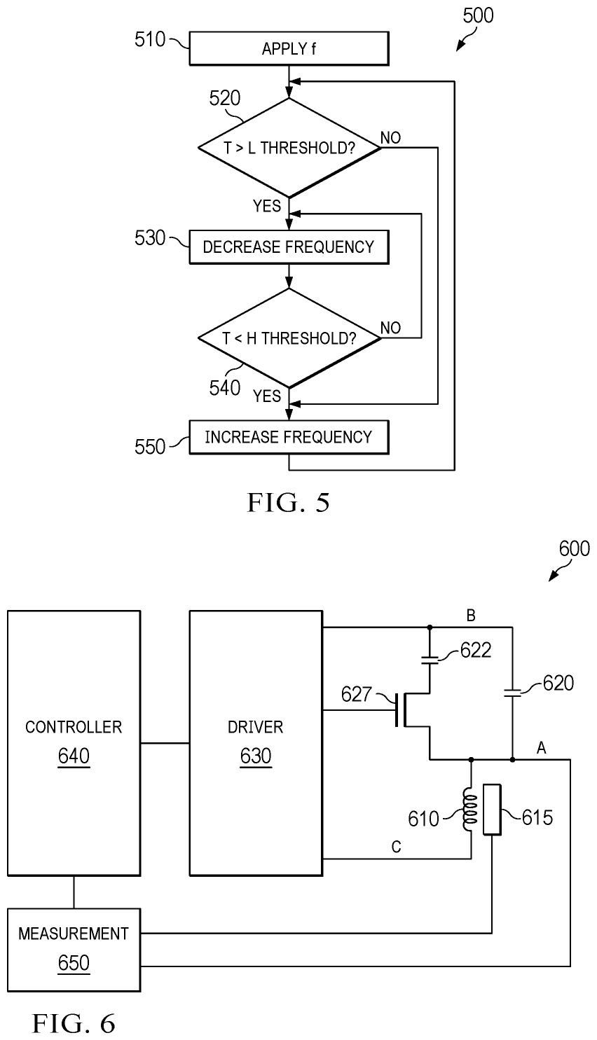

FIG. 5 shows a flowchart diagram illustrating a method 500 of using an e-cigarette heating system according to some embodiments. Method 500 may be performed, for example by a controller, such as controller 140 of e-cigarette heating system 100. In some embodiments, e-cigarette heating system 100 may be configured to perform a method which is different from method 500, and which, for example, has one or more aspects similar or identical to method 500. In some embodiments, the controller is configured to perform method 500 as part of performing method 300 discussed above, for example, at block 350.

At block 510, a heating signal having an operating frequency is applied to a heating circuit. In response to the heating signal, a heating element increases in temperature.

At block 520, the controller determines whether the temperature of the heating element is greater than a low threshold. For example, in some embodiments the controller determines whether the temperature of the heating element is greater than 250° C.

In response to the temperature of the heating element not being greater than the low threshold, at block 550, the operating frequency of the heating signal is increased, and the temperature of the heating element increases. In response to the temperature of the heating element being greater than the low threshold, at block 530, the operating frequency of the heating signal is decreased, and the temperature of the heating element decreases.

At block 540, the controller determines whether the temperature of the heating element is less than a high threshold. For example, in some embodiments the controller determines whether the temperature of the heating element is less than 270° C.

In response to the temperature of the heating element not being less than the high threshold, at block 530, the operating frequency of the heating signal is decreased, and the temperature of the heating element decreases. In response to the temperature of the heating element being less than the high threshold, at block 550, the operating frequency of the heating signal is increased, and the temperature of the heating element increases.

In some embodiments, using method 500, the controller causes the temperature of the heating element to substantially remain between the low threshold and the high threshold.

FIG. 6 shows a schematic circuit block diagram of an e-cigarette heating system 600 according to some embodiments. E-cigarette heating system 600 includes inductive coil 610, heating element 615, tank capacitor 620, selectable tank capacitor 622, control switch 627, driver 630, controller 640, and measurement circuit 650. E-cigarette heating system 600 is an example of a system having the beneficial aspects discussed herein. Other e-cigarette heating systems have one or more of the beneficial aspects discussed herein.

In the illustrated embodiment, driver 630 may be configured to perform those functions and methods discussed above with reference to driver 130 and FIGS. 1-5. In addition, in response to one or more signals from controller 640, driver 630 is configured to generate a control signal to control the conductivity state of control switch 627, as discussed in further detail below.

In the illustrated embodiment, measurement circuit 650 may be configured to perform those functions and methods discussed above with reference to measurement circuit 150 and FIGS. 1-5.

In the illustrated embodiment, controller 640 may be configured to perform those functions and methods discussed above with reference to controller 140 and FIGS. 1-5.

In some embodiments, controller 640 may be configured to receive a resonance frequency signal from measurement circuit 650, where the resonance frequency signal indicates a resonance frequency of the heating circuit. In addition, controller 640 may be configured to determine whether the resonance frequency of the heating circuit is greater than a threshold frequency.

In some embodiments, in response to the controller 640 determining that the resonance frequency of the heating circuit is greater than the threshold frequency, the controller 640 generates a signal for driver 630, where the signal causes driver 630 to increase the effective capacitance of the heating circuit. For example, in response to the signal, driver 630 may change the state of the control signal affecting the conductivity of control switch 627. In response to the changed state of the control signal, control switch 627 becomes conductive, and the capacitance of selectable tank capacitor 622 is effectively added to the capacitance of tank capacitor 620. As a result, the resonance frequency of the tank circuit is reduced.

In alternative embodiments, e-cigarette heating system 600 includes multiple selectable tank capacitors 620 which may each be selectively connected in parallel with tank capacitor 620 by a driver, for example, in response to signals from a controller.

In some embodiments, e-cigarette heating system 600 may be configured to perform the functions and methods described above with reference to e-cigarette heating system 100 and FIGS. 1-5.

In some embodiments, e-cigarette heating system 600 may be configured to change the effective capacitance of the heating circuit to cause the resonance frequency of the heating circuit to be persistently less than operating frequency of the heating signal, for example, based on a resonance frequency signal. In some embodiments, e-cigarette heating system 600 may be configured to subsequently change the operating frequency of the heating signal so as to control a temperature of the heating element 615.

In some embodiments, e-cigarette heating system 600 may be configured to change the effective capacitance of the heating circuit to cause the resonance frequency of the heating circuit to be persistently less than operating frequency of the heating signal, for example, based on a resonance frequency signal, and to further change the effective capacitance of the heating circuit to control a temperature of the heating element 615.

In some embodiments, e-cigarette heating system 600 may be configured to change the effective capacitance of the heating circuit to cause the resonance frequency of the heating circuit to be persistently greater than operating frequency of the heating signal, for example, based on a resonance frequency signal. In some embodiments, e-cigarette heating system 600 may be configured to subsequently change the operating frequency of the heating signal so as to control a temperature of the heating element 615.

In some embodiments, e-cigarette heating system 600 may be configured to change the effective capacitance of the heating circuit to cause the resonance frequency of the heating circuit to be persistently greater than operating frequency of the heating signal, for example, based on a resonance frequency signal, and to further change the effective capacitance of the heating circuit to control a temperature of the heating element 615.

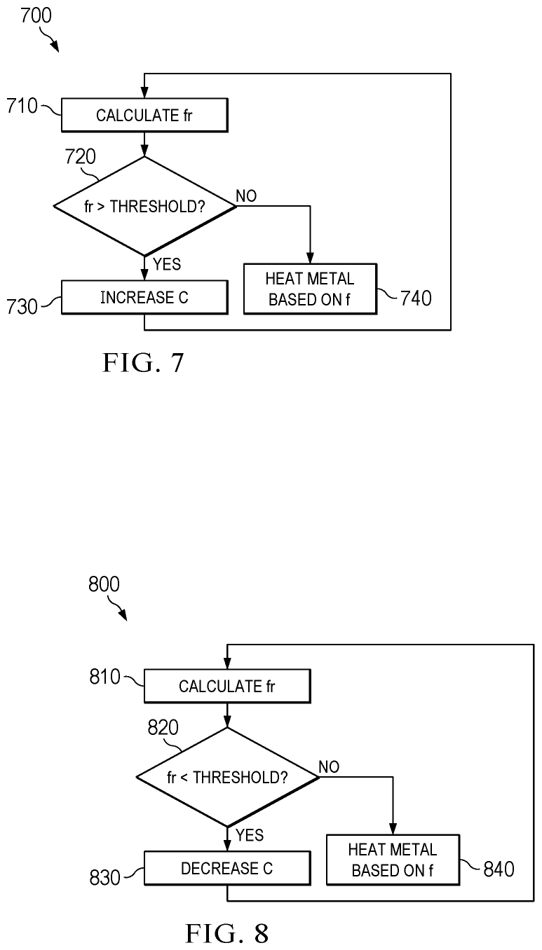

FIG. 7 shows a flowchart diagram illustrating a method 700 of using an e-cigarette heating system according to some embodiments. Method 700 may be performed, for example by a controller, such as controller 640 of e-cigarette heating system 600. In some embodiments, e-cigarette heating system 600 may be configured to perform a method which is different from method 700, and which, for example, has one or more aspects similar or identical to method 700. In some embodiments, the controller is configured to perform method 700 as part of performing method 300 discussed above, for example, at block 340.

At block 710, a resonance frequency of the heating circuit is determined. For example, the controller may determine the resonance frequency of the heating circuit using a method such as that discussed above with reference to FIG. 2.

At block 720, the controller determines whether the resonance frequency determined at block 710 is greater than a threshold frequency.

In response to the controller determining that the resonance frequency of the heating circuit is greater than the threshold frequency, at block 730 the controller generates a signal for a driver, such as driver 630, which causes the driver to increase the effective capacitance of the heating circuit. As a result, the resonance frequency of the tank circuit is reduced. In addition, the method 700 returns to block 710, where the resonance frequency of the heating circuit is again determined.

In response to the controller determining that the resonance frequency of the heating circuit is not greater than the threshold frequency, at block 740, a temperature of the heating element is controlled. In some embodiments, the temperature of the heating element is controlled by modifying the operating frequency of the heating signal. For example, method 400 or method 500 may be used. In some embodiments, the temperature of the heating element is controlled by modifying the effective capacitance of the heating circuit.

FIG. 8 shows a flowchart diagram illustrating a method 800 of using an e-cigarette heating system according to some embodiments. Method 800 may be performed, for example by a controller, such as controller 640 of e-cigarette heating system 600. In some embodiments, e-cigarette heating system 600 may be configured to perform a method which is different from method 800, and which, for example, has one or more aspects similar or identical to method 800. In some embodiments, the controller is configured to perform method 800 as part of performing method 300 discussed above, for example, at block 340.

At block 810, a resonance frequency of the heating circuit is determined. For example, the controller may determine the resonance frequency of the heating circuit using a method such as that discussed above with reference to FIG. 2.

At block 820, the controller determines whether the resonance frequency determined at block 810 is less than a threshold frequency.

In response to the controller determining that the resonance frequency of the heating circuit is less than the threshold frequency, at block 830 the controller generates a signal for a driver, such as driver 630, which causes the driver to decrease the effective capacitance of the heating circuit. As a result, the resonance frequency of the tank circuit is increased. In addition, the method 800 returns to block 810, where the resonance frequency of the heating circuit is again determined.

In response to the controller determining that the resonance frequency of the heating circuit is not less than the threshold frequency, at block 840, a temperature of the heating element is controlled. In some embodiments, the temperature of the heating element is controlled by modifying the operating frequency of the heating signal. For example, method 400 or method 500 may be used. In some embodiments, the temperature of the heating element is controlled by modifying the effective capacitance of the heating circuit.

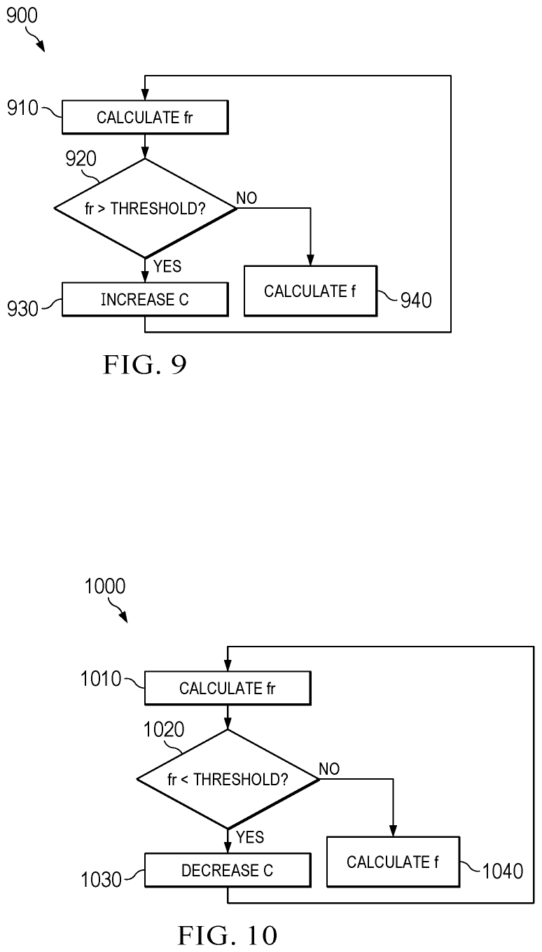

FIG. 9 shows a flowchart diagram illustrating a method 900 of using an e-cigarette heating system according to some embodiments. Method 900 may be performed, for example by a controller, such as controller 640 of e-cigarette heating system 600. In some embodiments, e-cigarette heating system 600 may be configured to perform a method which is different from method 900, and which, for example, has one or more aspects similar or identical to method 900. In some embodiments, the controller is configured to perform method 900 as part of performing method 300 discussed above, for example, at block 340.

At block 910, a resonance frequency of the heating circuit is determined. For example, the controller may determine the resonance frequency of the heating circuit using a method such as that discussed above with reference to FIG. 2.

At block 920, the controller determines whether the resonance frequency determined at block 910 is greater than a threshold frequency.

In response to the controller determining that the resonance frequency of the heating circuit is greater than the threshold frequency, at block 930 the controller generates a signal for a driver, such as driver 630, which causes the driver to increase the effective capacitance of the heating circuit. As a result, the resonance frequency of the tank circuit is reduced. In addition, the method 900 returns to block 910, where the resonance frequency of the heating circuit is again determined.

In response to the controller determining that the resonance frequency of the heating circuit is not greater than the threshold frequency, at block 940, an operating frequency of the heating signal is determined. In some embodiments, the operating frequency of the heating signal is determined to be greater than the resonance frequency of the heating circuit. In some embodiments, the operating frequency of the heating signal is determined to be less than the resonance frequency of the heating circuit.

In some embodiments, the temperature of the heating element is subsequently controlled. In some embodiments, the temperature of the heating element is controlled by modifying the operating frequency of the heating signal. For example, method 400 or method 500 may be used. In some embodiments, the temperature of the heating element is controlled by modifying the effective capacitance of the heating circuit.

FIG. 10 shows a flowchart diagram illustrating a method 1000 of using an e-cigarette heating system according to some embodiments. Method 1000 may be performed, for example by a controller, such as controller 640 of e-cigarette heating system 600. In some embodiments, e-cigarette heating system 600 may be configured to perform a method which is different from method 1000, and which, for example, has one or more aspects similar or identical to method 1000. In some embodiments, the controller is configured to perform method 1000 as part of performing method 300 discussed above, for example, at block 340.

At block 1010, a resonance frequency of the heating circuit is determined. For example, the controller may determine the resonance frequency of the heating circuit using a method such as that discussed above with reference to FIG. 2.

At block 1020, the controller determines whether the resonance frequency determined at block 1010 is less than a threshold frequency.

In response to the controller determining that the resonance frequency of the heating circuit is less than the threshold frequency, at block 1030 the controller generates a signal for a driver, such as driver 630, which causes the driver to decrease the effective capacitance of the heating circuit. As a result, the resonance frequency of the tank circuit is increased. In addition, the method 1000 returns to block 1010, where the resonance frequency of the heating circuit is again determined.

In response to the controller determining that the resonance frequency of the heating circuit is not less than the threshold frequency, at block 1040, an operating frequency of the heating signal is determined. In some embodiments, the operating frequency of the heating signal is determined to be greater than the resonance frequency of the heating circuit. In some embodiments, the operating frequency of the heating signal is determined to be less than the resonance frequency of the heating circuit.

In some embodiments, the temperature of the heating element is subsequently controlled. In some embodiments, the temperature of the heating element is controlled by modifying the operating frequency of the heating signal. For example, method 400 or method 500 may be used. In some embodiments, the temperature of the heating element is controlled by modifying the effective capacitance of the heating circuit.

Examples of the present invention are summarized here. Other examples can also be understood from the entirety of the specification and the claims.

Example 1. One embodiment an e-cigarette heating system, including a heating element; an inductive coil configured to transfer energy to the heating element in response to a heating signal; a tank capacitor; a driver configured to generate the heating signal; a controller configured to cause the driver to generate the heating signal; an analog to digital converter configured to digitize an analog signal indicating a resonance frequency of the tank capacitor and the inductive coil; and a digital circuit configured to transmit a resonance frequency signal providing an indication of the resonance frequency of the tank capacitor and the inductive coil to the controller, where the digital circuit is configured to transmit a Q signal to the controller, where the Q signal provides an indication of a quality factor (Q) of the tank capacitor and the inductive coil to the controller, where the controller is configured to determine an operating frequency of the heating signal based on the resonance frequency signal, and where the controller is configured to determine an aging condition of the inductive coil based on the Q signal of the tank capacitor in the inductive coil.

Example 2. The e-cigarette heating system of example 1, where the controller is configured to set the operating frequency of the heating signal to be a predetermined fixed factor greater than the resonance frequency of the of the tank capacitor and the inductive coil.

Example 3. The e-cigarette heating system of example 1, where the digital circuit is configured to transmit a temperature signal to the controller, where the temperature signal provides an indication of a temperature of the heating element, and where the controller is configured to modify the temperature of the heating element in response to the temperature signal.

Example 4. The e-cigarette heating system of example 3, where the controller is configured to modify the temperature of the heating element by changing the operating frequency of the heating signal in response to the temperature signal.

Example 5. The e-cigarette heating system of example 4, where the controller is configured to increase the temperature of the heating element by decreasing the operating frequency of the heating signal in response to the temperature signal, and where the controller is configured to decrease the temperature of the heating element by increasing the operating frequency of the heating signal in response to the temperature signal.

Example 6. The e-cigarette heating system of example 1, where the controller is configured to set the operating frequency of the heating signal to be a predetermined fixed factor greater than the resonance frequency of the of the tank capacitor and the inductive coil in response to the aging condition indicating that the inductive coil has aged less than a threshold condition.

Example 7. The e-cigarette heating system of example 1, where the controller is configured to set the operating frequency of the heating signal to be less than the resonance frequency of the of the tank capacitor and the inductive coil, where the controller is configured to increase the temperature of the heating element by increasing the operating frequency of the heating signal in response to the temperature signal, and where the controller is configured to decrease the temperature of the heating element by decreasing the operating frequency of the heating signal in response to the temperature signal.

Example 8. Another embodiment is an e-cigarette heating system, including a heating element; an inductive coil configured to transfer energy to the heating element in response to a heating signal; a fixed tank capacitor; a selectable tank capacitor; a driver configured to generate the heating signal; a controller configured to cause the driver to generate the heating signal; and a measurement circuit, where the measurement circuit is configured to transmit a resonance frequency signal providing an indication of a resonance frequency of the fixed tank capacitor and the inductive coil to the controller, where the controller is configured to cause the selectable tank capacitor to be connected across the fixed tank capacitor in response to the resonance frequency signal indicating that the resonance frequency of the fixed tank capacitor and the inductive coil is greater than a frequency threshold.

Example 9. The e-cigarette heating system of example 8, where the measurement circuit is configured to transmit a second resonance frequency signal providing an indication of a resonance frequency of the selectable tank capacitor, the fixed tank capacitor, and the inductive coil to the controller, and where the controller is configured to determine an operating frequency of the heating signal based on the second resonance frequency signal.

Example 10. The e-cigarette heating system of example 9, where the controller is configured to set the operating frequency of the heating signal to be a predetermined fixed factor greater than the second resonance frequency.

Example 11. The e-cigarette heating system of example 8, where the measurement circuit is configured to transmit a Q signal to the controller, where the Q signal provides an indication of a quality factor (Q) of the selectable tank capacitor, the fixed tank capacitor, and the inductive coil to the controller, and where the controller is configured to determine an aging condition of the inductive coil based on the Q signal.

Example 12. The e-cigarette heating system of example 8, where the measurement circuit is configured to transmit a temperature signal to the controller, where the temperature signal provides an indication of a temperature of the heating element, and where the controller is configured to modify the temperature of the heating element in response to the temperature signal.

Example 13. The e-cigarette heating system of example 12, where the controller is configured to modify the temperature of the heating element by changing the operating frequency of the heating signal in response to the temperature signal.

Example 14. The e-cigarette heating system of example 13, where the controller is configured to increase the temperature of the heating element by decreasing the operating frequency of the heating signal in response to the temperature signal, and where the controller is configured to decrease the temperature of the heating element by increasing the operating frequency of the heating signal in response to the temperature signal.

Example 15. Another embodiment is a method of using an e-cigarette heating system, the method including determining a quality (Q) factor of a heating circuit; determining an aging condition of the heating circuit based on the Q factor; determining a resonance frequency of the heating circuit; determining an operating frequency of the heating circuit based on the resonance frequency of the heating circuit; and generating a heating signal having the operating frequency to heat a heating element with the heating circuit.

Example 16. The method of example 15, further including setting the operating frequency of the heating circuit to be a predetermined fixed factor greater than the resonance frequency of the of the heating circuit.

Example 17. The method of example 15, further including changing the operating frequency of the heating signal to modify a temperature of the heating element in response to a temperature signal indicating a temperature of the heating element.

Example 18. The method of example 17, where increasing the operating frequency of the heating signal causes the temperature of the heating element to decrease, and where decreasing the operating frequency of the heating signal causes the temperature of the heating element to increase.

Example 19. The method of example 15, further including setting the operating frequency of the heating signal to be a predetermined fixed factor greater than the resonance frequency of the heating circuit.

Example 20. The method of example 15, further including changing an effective capacitance of the heating circuit in response to the resonance frequency being greater than a frequency threshold.

What is claimed is:

1. An e-cigarette heating system, comprising:
a heating element;
an inductive coil configured to transfer energy to the heating element in response to a heating signal;
a tank capacitor;
a driver configured to generate the heating signal;
a controller configured to cause the driver to generate the heating signal;
an analog to digital converter configured to digitize an analog signal indicating a resonance frequency of the tank capacitor and the inductive coil; and
a digital circuit configured to transmit a resonance frequency signal providing an indication of the resonance frequency of the tank capacitor and the inductive coil to the controller, wherein the digital circuit is configured to transmit a Q signal to the controller, wherein the Q signal provides an indication of a quality factor (Q) of the tank capacitor and the inductive coil to the controller,
wherein the controller is configured to determine an operating frequency of the heating signal based on the resonance frequency signal, and
wherein the controller is configured to determine an aging condition of the inductive coil based on the Q signal of the tank capacitor in the inductive coil.

2. The e-cigarette heating system of claim 1, wherein the controller is configured to set the operating frequency of the heating signal to be a predetermined fixed factor greater than the resonance frequency of the of the tank capacitor and the inductive coil.

3. The e-cigarette heating system of claim 1, wherein the digital circuit is configured to transmit a temperature signal to the controller, wherein the temperature signal provides an indication of a temperature of the heating element, and wherein the controller is configured to modify the temperature of the heating element in response to the temperature signal.

4. The e-cigarette heating system of claim 3, wherein the controller is configured to modify the temperature of the heating element by changing the operating frequency of the heating signal in response to the temperature signal.

5. The e-cigarette heating system of claim 4, wherein the controller is configured to increase the temperature of the heating element by decreasing the operating frequency of the heating signal in response to the temperature signal, and wherein the controller is configured to decrease the temperature of the heating element by increasing the operating frequency of the heating signal in response to the temperature signal.

6. The e-cigarette heating system of claim 1, wherein the controller is configured to set the operating frequency of the heating signal to be a predetermined fixed factor greater than the resonance frequency of the of the tank capacitor and the inductive coil in response to the aging condition indicating that the inductive coil has aged less than a threshold condition.

7. The e-cigarette heating system of claim 1, wherein the controller is configured to set the operating frequency of the heating signal to be less than the resonance frequency of the of the tank capacitor and the inductive coil, wherein the controller is configured to increase the temperature of the heating element by increasing the operating frequency of the heating signal in response to the temperature signal, and wherein the controller is configured to decrease the temperature of the heating element by decreasing the operating frequency of the heating signal in response to the temperature signal.

8. An e-cigarette heating system, comprising:
a heating element;
an inductive coil configured to transfer energy to the heating element in response to a heating signal;
a fixed tank capacitor;
a selectable tank capacitor;
a driver configured to generate the heating signal;
a controller configured to cause the driver to generate the heating signal; and
a measurement circuit, wherein the measurement circuit is configured to transmit a resonance frequency signal providing an indication of a resonance frequency of the fixed tank capacitor and the inductive coil to the controller,
wherein the controller is configured to cause the selectable tank capacitor to be connected across the fixed tank capacitor in response to the resonance frequency signal indicating that the resonance frequency of the fixed tank capacitor and the inductive coil is greater than a frequency threshold.

9. The e-cigarette heating system of claim 8, wherein the measurement circuit is configured to transmit a second resonance frequency signal providing an indication of a resonance frequency of the selectable tank capacitor, the fixed tank capacitor, and the inductive coil to the controller, and wherein the controller is configured to determine an operating frequency of the heating signal based on the second resonance frequency signal.

10. The e-cigarette heating system of claim 9, wherein the controller is configured to set the operating frequency of the heating signal to be a predetermined fixed factor greater than the second resonance frequency.

11. The e-cigarette heating system of claim 8, wherein the measurement circuit is configured to transmit a Q signal to the controller, wherein the Q signal provides an indication of a quality factor (Q) of the selectable tank capacitor, the fixed tank capacitor, and the inductive coil to the controller, and wherein the controller is configured to determine an aging condition of the inductive coil based on the Q signal.

12. The e-cigarette heating system of claim 8, wherein the measurement circuit is configured to transmit a temperature signal to the controller, wherein the temperature signal provides an indication of a temperature of the heating element, and wherein the controller is configured to modify the temperature of the heating element in response to the temperature signal.

13. The e-cigarette heating system of claim 12, wherein the controller is configured to modify the temperature of the heating element by changing the operating frequency of the heating signal in response to the temperature signal.

14. The e-cigarette heating system of claim 13, wherein the controller is configured to increase the temperature of the heating element by decreasing the operating frequency of the heating signal in response to the temperature signal, and wherein the controller is configured to decrease the temperature of the heating element by increasing the operating frequency of the heating signal in response to the temperature signal.

15. A method of using an e-cigarette heating system, the method comprising:
determining a quality (Q) factor of a heating circuit;
determining an aging condition of the heating circuit based on the Q factor;
determining a resonance frequency of the heating circuit;
determining an operating frequency of the heating circuit based on the resonance frequency of the heating circuit; and
generating a heating signal having the operating frequency to heat a heating element with the heating circuit.

16. The method of claim 15, further comprising setting the operating frequency of the heating circuit to be a predetermined fixed factor greater than the resonance frequency of the of the heating circuit.

17. The method of claim 15, further comprising changing the operating frequency of the heating signal to modify a temperature of the heating element in response to a temperature signal indicating a temperature of the heating element.

18. The method of claim 17, wherein increasing the operating frequency of the heating signal causes the temperature of the heating element to decrease, and wherein decreasing the operating frequency of the heating signal causes the temperature of the heating element to increase.

19. The method of claim 15, further comprising setting the operating frequency of the heating signal to be a predetermined fixed factor greater than the resonance frequency of the heating circuit.

20. The method of claim 15, further comprising changing an effective capacitance of the heating circuit in response to the resonance frequency being greater than a frequency threshold.
